(19) United States
(12) Patent Application Publication
(10) Pub. No.: US 2024/0317090 A1
(43) Pub. Date: Sep. 26, 2024

(54) CHARGING SYSTEM FOR ELECTRIC VEHICLE

(71) Applicant: HONDA MOTOR CO., LTD., Tokyo (JP)

(72) Inventor: Yoshihisa KUBOTA, Saitama-ken (JP)

(21) Appl. No.: 18/436,136

(22) Filed: Feb. 8, 2024

(30) Foreign Application Priority Data
Mar. 22, 2023 (JP) 2023-045858
Nov. 28, 2023 (JP) 2023-200571

(51) Int. Cl. B60L 53/24; B60L 53/22; B60L 53/60; H02K 1/12; H02K 1/2706; H02P 27/06

(52) U.S. Cl. CPC B60L 53/24; B60L 53/22; B60L 53/60; H02K 1/12; H02K 1/2706; H02P 27/06; B60L 2210/10

(57) ABSTRACT

A charging system for an electric vehicle charging a battery from an external power supply using a motor for driving of the electric vehicle, and an inverter, in which a control device charges the battery by controlling direct current of the external power supply to be applied to first to fourth winding portions at the time of DC charging, and charges the battery by controlling to electrically connect the external power supply to the third winding portion and/or the fourth winding portion and stop a rotor at a predetermined position at the time of AC charging.

### BACKGROUND

### Technical Field

The present invention relates to a charging system for an electric vehicle, and more particularly to a charging system for charging a battery using a motor for driving of an electric vehicle and an inverter.

### Related Art

In recent years, efforts to achieve a low-carbon society or a decarbonized society have been activated as measures against global climate change. Also in vehicles, a reduction in CO2 emission has been strongly demanded, and electrification of power sources is rapidly progressing. As a charging system for a battery that supplies power to a driving motor used as such a power source, for example, that described in JP 2021-5944 A is conventionally known.

This charging system is mounted on a vehicle, and includes a motor generator, two batteries, two inverters, an in-vehicle charger, and a control unit. When quick charging is performed, direct current power supplied from a quick charger installed outside the vehicle flows through coils of the respective phases of the motor generator and the respective inverters as energization paths, and the respective batteries are charged. On the other hand, when normal charging is performed, alternating current power supplied from an alternating current power source outside the vehicle is converted into direct current power by the in-vehicle charger, and the converted direct current power is charged in each battery.

### CITATION LIST

### Patent Literature

Patent Literature 1: JP 2021-5944 A

### SUMMARY

As described above, in the above-described charging system, quick charging by direct current power is performed via the coils of the motor generator and the inverters. However, when normal charging is performed, the in-vehicle charger is used to convert alternating current power into direct current power. Therefore, in the above-described charging system, the number of components increases because of the in-vehicle charger, and the cost increases, and a space for installing the in-vehicle charger is required in the vehicle.

The present invention has been made to solve the above problem, and an object is to provide a charging system for an electric vehicle that can perform normal charging in addition to quick charging using a motor for driving and an inverter, thereby reducing the number of components and cost of the entire charging system by omitting an in-vehicle charger.

In order to achieve the above-described object, an invention according to claim 1 is a charging system for an electric vehicle that charges a battery from an external power supply using a motor for driving of the electric vehicle, and an inverter, wherein the motor includes a rotor including a permanent magnet, a stator disposed outside the rotor, a winding of a first phase including a first winding portion and a second winding portion wound around the stator and facing each other with the rotor interposed therebetween, and a winding of a second phase including a third winding portion and a fourth winding portion wound around the stator and facing each other with the rotor interposed therebetween, the winding of the second phase being disposed in a state of being displaced by 90 degrees in terms of electrical angle with respect to the winding of the first phase, the inverter includes first to fourth H-bridge circuits connected to the battery and connected to the first and second winding portions of the first phase and the third and fourth winding portions of the second phase, respectively, and first and second bidirectional switches switching a bidirectional current flow through the first and second winding portions and a bidirectional current flow through the third and fourth winding portions, respectively, to an on state or an off state, the first to fourth H-bridge circuits respectively include first and second legs, third and fourth legs, fifth and sixth legs, and seventh and eighth legs in which upper arms and lower arms each including a switching element are connected to each other at midpoints, and the midpoints of the first and second legs are respectively connected to one end and the other end of the first winding portion, the midpoints of the third and fourth legs are respectively connected to one end and the other end of the second winding portion, the midpoints of the fifth and sixth legs are respectively connected to one end and the other end of the third winding portion, and the midpoints of the seventh and eighth legs are respectively connected to one end and the other end of the fourth winding portion, the charging system including: a control device that controls the first to fourth H-bridge circuits, the first and second bidirectional switches, and a stop position of the rotor, the control device charging the battery by controlling direct current from the external power supply to be applied to the first to fourth winding portions at the time of DC charging, and charging the battery by electrically connecting the external power supply to the third winding portion and/or the fourth winding portion and controlling the rotor to stop at a predetermined position at the time of AC charging.

With this configuration, the motor for driving of the electric vehicle includes the winding of the first phase including the first winding portion and the second winding portion described above, and the winding of the second phase including the third winding portion and the fourth winding portion described above. In addition, the inverter includes the first to fourth H-bridge circuits described above and the first and second bidirectional switches described above. The first to fourth H-bridge circuits include the first and second legs, third and fourth legs, fifth and sixth legs, and seventh and eighth legs, respectively. Then, one end and the other end of each of the first to fourth winding portions are connected to the midpoints of the first to eighth legs as described above.

The first to fourth H-bridge circuits, the first and second bidirectional switches, and the stop position of the rotor are controlled by the control device at the time of DC charging and at the time of AC charging as described below. Specifically, at the time of DC charging, direct current from the external power supply is controlled to be applied to the first to fourth winding portions, thereby charging the battery. On the other hand, at the time of AC charging, the external power supply is controlled to be electrically connected to the third winding portion and/or the fourth winding portion, and the rotor is controlled to stop at a predetermined position, for example, a position where the first phase and the second phase do not magnetically interfere with each other, thereby charging the battery. As described above, according to the present invention, it is possible to perform normal charging by AC charging in addition to quick charging by DC charging using the motor for driving and the inverter, thereby reducing the number of components and cost of the entire charging system by omitting an in-vehicle charger unlike the conventional art. Note that when one end of the third winding portion or the fourth winding portion is connected to the external power supply at the time of AC charging, the above-described one end is connected to the external power supply in a state of being disconnected from the leg of the inverter.

An invention according to claim 2 is a charging system for an electric vehicle that charges a battery from an external power supply using a motor for driving of the electric vehicle, and an inverter, wherein the motor includes a rotor including a permanent magnet, a stator disposed outside the rotor, a winding of a first phase including a first winding portion and a second winding portion wound around the stator, and a winding of a second phase including a third winding portion and a fourth winding portion wound around the stator, the winding of the second phase being disposed in a state of being displaced by 90 degrees in terms of electrical angle with respect to the winding of the first phase, the inverter includes first to fourth H-bridge circuits connected to the battery and connected to the first and second winding portions of the first phase and the third and fourth winding portions of the second phase, respectively, the first to fourth H-bridge circuits respectively include first and second legs, third and fourth legs, fifth and sixth legs, and seventh and eighth legs in which upper arms and lower arms each including a switching element are connected to each other at midpoints, and the midpoints of the first and second legs are respectively connected to one end and the other end of the first winding portion, the midpoints of the third and fourth legs are respectively connected to one end and the other end of the second winding portion, the midpoints of the fifth and sixth legs are respectively connected to one end and the other end of the third winding portion, and the midpoints of the seventh and eighth legs are respectively connected to one end and the other end of the fourth winding portion, the charging system including: a control device that controls the first to fourth H-bridge circuits, the control device charging the battery by controlling to electrically connect the external power supply to the third winding portion and/or the fourth winding portion at the time of AC charging.

With this configuration, the motor for driving of the electric vehicle includes the winding of the first phase including the first winding portion and the second winding portion described above, and the winding of the second phase including the third winding portion and the fourth winding portion described above. In addition, the inverter includes the first to fourth H-bridge circuits described above and the first and second bidirectional switches described above. The first to fourth H-bridge circuits include the first and second legs, third and fourth legs, fifth and sixth legs, and seventh and eighth legs, respectively. Then, one end and the other end of each of the first to fourth winding portions are connected to the midpoints of the first to eighth legs as described above.

At the time of AC charging, the control device that controls the first to fourth H-bridge circuits controls the external power supply to be electrically connected to the third winding portion and/or the fourth winding portion, thereby charging the battery. As described above, according to the present invention, it is possible to perform normal charging by AC charging using the motor for driving and the inverter, thereby reducing the number of components and cost of the entire charging system by omitting an in-vehicle charger unlike the conventional art. Note that when one end of the third winding portion or the fourth winding portion is connected to the external power supply at the time of AC charging, the above-described one end is connected to the external power supply in a state of being disconnected from the leg of the inverter.

An invention according to claim 3 is the charging system for an electric vehicle according to claim 2, wherein the control device charges the battery by controlling direct current from the external power supply to be applied to the first to fourth winding portions at the time of DC charging.

With this configuration, at the time of DC charging, the control device controls direct current from the external power supply to be applied to the first to fourth winding portions, thereby charging the battery. As a result, quick charging by DC charging can be performed in addition to normal charging by AC charging using the motor for driving and the inverter.

An invention according to claim 4 is the charging system for an electric vehicle according to claim 1, wherein the control device controls the third and fourth H-bridge circuits to function as a power factor correction circuit and controls the first and second H-bridge circuits to function as an isolated DC-DC converter, at the time of AC charging.

With this configuration, the control device causes the third and fourth H-bridge circuits to function as the power factor correction circuits at the time of AC charging, and thus, it is possible to reduce the harmonic component of the alternating current of the external power supply and to approximate to the sine wave of the fundamental wave. In addition, since the first and second H-bridge circuits function as the isolated DC-DC converters at the time of AC charging, the direct current from the third and fourth H-bridge circuits as the power factor correction circuits can be converted into a predetermined voltage, and the battery can be efficiently charged.

### BRIEF DESCRIPTION OF DRAWINGS

FIG. 1 is a block diagram illustrating a schematic configuration of a charging system for an electric vehicle according to an embodiment of the present invention;

FIG. 2 is a diagram illustrating a configuration of a motor and a connection relationship between windings of the motor and a power supply/charging circuit;

FIG. 3 is a circuit diagram illustrating the power supply/charging circuit of the charging system for an electric vehicle according to the embodiment of the present invention;

FIG. 4 is a diagram illustrating an operation of the power supply/charging circuit in a series winding mode;

FIG. 5 is a diagram illustrating an operation of the power supply/charging circuit in a parallel winding mode;

FIGS. 6A to 6C are diagrams illustrating a connection state between the power supply/charging circuit and an external power supply (alternating current) at the time of normal charging (AC charging) and an angular position of a rotor;

FIGS. 7A to 7C are diagrams illustrating a connection state between the power supply/charging circuit (series pattern) and an external power supply (direct current) at the time of quick charging (DC charging, 400 V) and an angular position of a rotor;

FIG. 8 is a diagram illustrating an operation of the power supply/charging circuit at the time of quick charging of FIGS. 7A to 7C;

FIG. 9 is a diagram illustrating a connection state between the power supply/charging circuit (parallel pattern) and an external power supply (direct current) at the time of quick charging (DC charging, 400 V);

FIG. 10 is a diagram illustrating an operation of the power supply/charging circuit at the time of quick charging of FIG. 9;

FIG. 11 is a diagram illustrating another connection state between the power supply/charging circuit (parallel pattern) and an external power supply (direct current) at the time of quick charging (DC charging, 400 V);

FIG. 12 is a diagram illustrating an operation of the power supply/charging circuit at the time of quick charging of FIG. 11;

FIG. 13 is a diagram illustrating a connection state between the power supply/charging circuit and an external power supply (direct current) at the time of super quick charging (DC charging, 800 V);

FIG. 14 is a diagram illustrating an operation of the power supply/charging circuit at the time of super quick charging of FIG. 13;

FIG. 15 is a diagram similar to FIG. 2, and illustrates a state in which a first winding portion and a second winding portion are wound around a common tooth, and a third winding portion and a fourth winding portion are wound around a common tooth;

FIG. 16 is a diagram illustrating a modification of the connection state of connection state of the input/output terminals of the external power supply at the time of AC charging;

FIG. 17 is a diagram illustrating an operation of the power supply/charging circuit at the time of super quick charging; and

FIGS. 18A and 18B are enlarged diagrams illustrating a first bidirectional switch and a second bidirectional switch. FIG. 18A is a switching circuit used in each power supply/charging circuit and FIG. 18B is another switching circuit.

### DETAILED DESCRIPTION

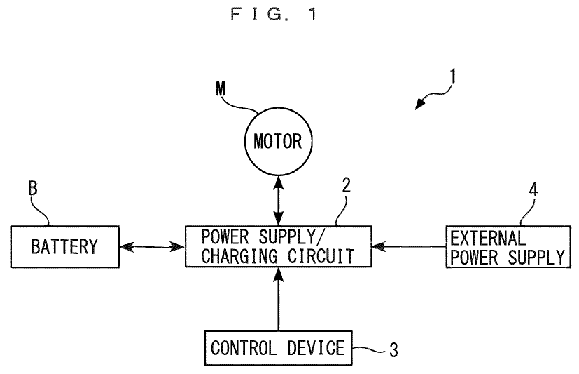

Hereinafter, a preferred embodiment of the present invention will be described in detail with reference to the drawings. As illustrated in FIG. 1, a charging system 1 to which the present invention is applied is applied to an electric vehicle, and includes a motor M for driving, a power supply/charging circuit 2 (inverter) that supplies power to the motor M and charges a battery B via the motor M, and a control device 3 that controls the power supply/charging circuit 2. At the time of charging, the power supply/charging circuit 2 is connected to an external power supply 4 capable of DC charging and AC charging, and power is supplied to the charging system 1.

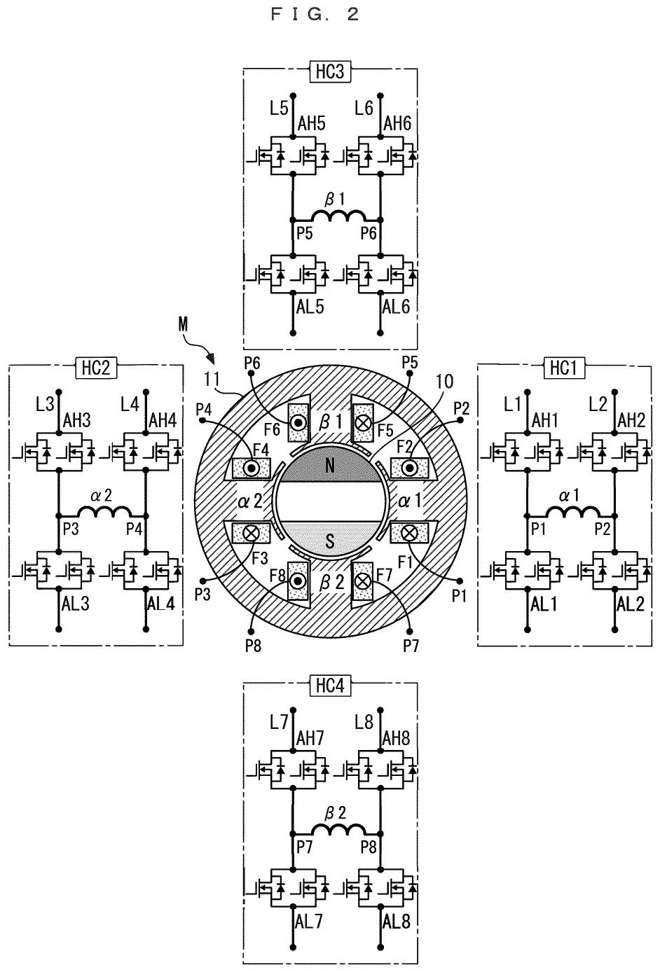

As illustrated in FIG. 2, the motor M is a two-phase synchronous motor including a rotor 10 including a permanent magnet, a stator 11 disposed on an outer peripheral side thereof, and a winding of α phase (first phase) and a winding of β phase (second phase) wound around the stator 11, and is configured by, for example, a brushless motor. The winding of the α phase and the winding of the β phase (hereinafter, simply referred to as a “winding α” and a “winding β”, respectively) are disposed in a state of being displaced by 90 degrees in terms of electrical angle. The winding α includes a first winding portion α1 and a second winding portion α2, and the winding β includes a third winding portion β1 and a fourth winding portion β2. The numbers of turns of the first to fourth winding portions α1, α2, β1, and β2 are equal to each other.

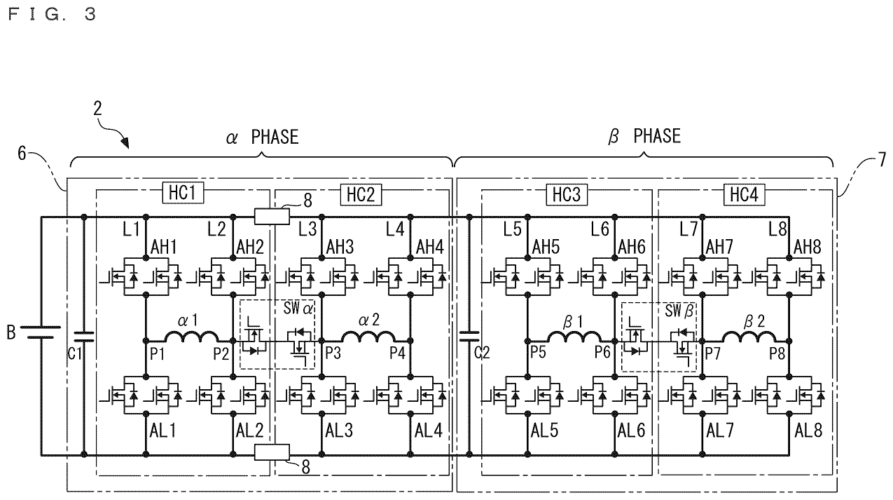

As illustrated in FIG. 1, the power supply/charging circuit 2 includes an inverter circuit that converts direct-current input power from the battery B into alternating current and supplies the alternating current to the motor M when the motor M is driven, and that converts alternating-current or direct-current power from the external power supply 4 into boosting voltage and/or direct current via the motor M and charges the battery B when the battery B is charged. In addition, as illustrated in FIG. 3, the power supply/charging circuit 2 includes a first circuit 6 connected to the battery B and connected to the winding α (first winding portion α1 and second winding portion α2) of the motor M, and a second circuit 7 connected to the battery B in parallel with the first circuit 6 and connected to the winding β (third winding portion β1 and fourth winding portion β2) of the motor M.

The first circuit 6 includes first to fourth legs L1 to L4, a first bidirectional switch SWα, and a smoothing capacitor C1, and these first to fourth legs L1 to L4 and the first smoothing capacitor C1 are connected in parallel to the battery B.

The first to fourth legs L1 to L4 have the same configuration. Specifically, the first leg L1 includes, for example, an upper arm AH1 in which two sets of circuits each including a switching element and a freewheeling diode parallel to each other are connected in parallel with each other, and a lower arm AL1 including two switching elements and freewheeling diodes in the same manner as the above-described upper arm AH1 and connected in series to the upper arm AH1 via a midpoint P1. The second leg L2 includes an upper arm AH2 and a lower arm AL2 having the same configuration as the first leg L1, and the lower arm AL2 is connected in series to the upper arm AH2 via a midpoint P2. The third leg L3 includes an upper arm AH3 and a lower arm AL3 having the same configuration as the first leg L1, and the lower arm AL3 is connected in series to the upper arm AH3 via a midpoint P3. The fourth leg L4 includes an upper arm AH4 and a lower arm AL4 having the same configuration as the first leg L1, and the lower arm AL4 is connected in series to the upper arm AH4 via a midpoint P4.

Then, as illustrated in FIG. 2, one end of the first winding portion α1 of the motor M is connected to the midpoint P1 of the first leg L1 via a first lead wire F1, and the other end of the first winding portion α1 is connected to the midpoint P2 of the second leg L2 via a second lead wire F2. In addition, one end of the second winding portion α2 of the motor M is connected to the midpoint P3 of the third leg L3 via a third lead wire F3, and the other end of the second winding portion α2 is connected to the midpoint P4 of the fourth leg L4 via a fourth lead wire F4.

As is apparent from the above configuration, the upper and lower arms AH1 and AL1 of the first leg L1 and the upper and lower arms AH2 and AL2 of the second leg L2 constitute a first H-bridge circuit HC1, and the direction of the current flowing through the first winding portion α 1 is switched by appropriately switching on/off states of their switching elements. Similarly, the upper and lower arms AH3 and AL3 of the third leg L3 and the upper and lower arms AH4 and AL4 of the fourth leg L4 constitute a second H-bridge circuit HC2, and the direction of the current flowing through the second winding portion α2 is switched by appropriately switching on/off states of their switching elements.

The first bidirectional switch SWα is obtained by connecting the two sets of circuits each including a switching element and a diode parallel to each other in series in opposite directions to each other (connecting forward directions or reverse directions of the diodes), and can switch a bidirectional current flow through the first bidirectional switch SWα between an on state and an off state by switching control of the two sets of switching elements. The first bidirectional switch SWα is disposed between the first H-bridge circuit HC1 and the second H-bridge circuit HC2 described above, more specifically, between the midpoint P2 of the second leg L2 and the midpoint P3 of the third leg L3.

Note that, between the second leg L2 of the first H-bridge circuit HC1 and the third leg L3 of the second H-bridge circuit HC2, contactors 8 and 8 capable of switching the connection between of the legs L2 and L3 between on/off states are provided. Note that these contactors 8 and 8 switch the above-described connection between on/off states as described below. That is, when the motor M is driven, the above-described connection is switched to the on state for driving energization. In addition, at the time of quick charging (DC charging), the above-described connection is switched to the on state for charging energization. Further, at the time of normal charging (AC charging), the above-described connection is switched to the off state for isolation.

Since the second circuit 7 is configured similarly to the first circuit 6 described above, brief description will be given below. As illustrated in FIG. 3, the second circuit 7 includes fifth to eighth legs L5 to L8, a second bidirectional switch SWβ, and a second smoothing capacitor C2. The fifth to eighth legs L5 to L8 and the second smoothing capacitor C2 are connected in parallel to the battery B.

The fifth to eighth legs L5 to L8 have the same configuration, and include, for example, upper arms AH5 to AH8 in which two sets of circuits including switching elements and freewheeling diodes in parallel with each other are connected in parallel with each other, and lower arms AL5 to AL8 configured in the same manner as the above and connected in series to the upper arms AH5 to AH8 via midpoints P5 to P8, respectively.

As illustrated in FIG. 2, one end of the third winding portion β1 of the motor M is connected to the midpoint P5 of the fifth leg L5 via a fifth lead wire F5, and the other end of the third winding portion β1 is connected to the midpoint P6 of the sixth leg L6 via a sixth lead wire F6. In addition, one end of the fourth winding portion β2 of the motor M is connected to the midpoint P7 of the seventh leg L7 via a seventh lead wire F7, and the other end of the fourth winding portion β2 is connected to the midpoint P8 of the eighth leg L8 via an eighth lead wire F8.

In addition, the upper and lower arms AH5 and AL5 of the fifth leg L5 and the upper and lower arms AH6 and AL6 of the sixth leg L6 constitute a third H-bridge circuit HC3, and the direction of the current flowing through the third winding portion β1 is switched by appropriately switching on/off states of their switching elements. Similarly, the upper and lower arms AH7 and AL7 of the seventh leg L7 and the upper and lower arms AH8 and AL8 of the eighth leg L8 constitute a fourth H-bridge circuit HC4, and the direction of the current flowing through the fourth winding portion β2 is switched by appropriately switching on/off states of their switching elements.

Similarly to the first bidirectional switch SWα, for example, the second bidirectional switch SWβ is obtained by connecting two sets of circuits each including a switching element and a diode parallel to each other in series in opposite directions to each other. The bidirectional current flow through the second bidirectional switch SWβ can be switched between the on state and the off state by the switching control of the two sets of switching elements. The second bidirectional switch SWβ is disposed between the third H-bridge circuit HC3 and the fourth H-bridge circuit HC4, more specifically, between the midpoint P6 of the sixth leg L6 and the midpoint P7 of the seventh leg L7.

The control device 3 includes a microcomputer including a CPU, RAM, ROM, an input/output interface (none of which is illustrated), and the like. The control device 3 controls the first to fourth H-bridge circuits HC1 to HC4 of the power supply/charging circuit 2, the first and second bidirectional switches SWα and SWβ, the stop position of the rotor 10 of the motor M, and the like.

In the power supply/charging circuit 2 configured as described above, when the motor M is driven by the battery B, the on/off states of the first and second bidirectional switches SWα and SWβ are switched, whereby the connection mode of the windings α and β of the motor M is switched between the series winding mode and the parallel winding mode described below.

### Series Winding Mode

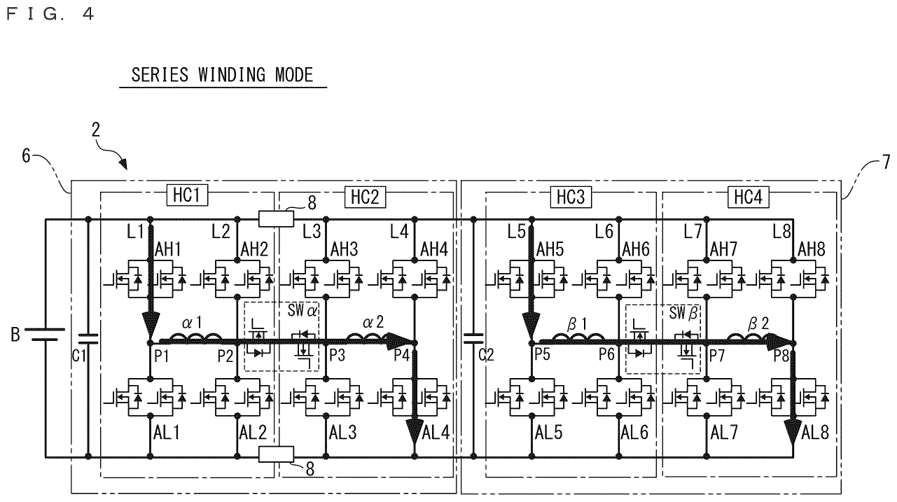

As illustrated in FIG. 4, in the series winding mode, both the first and second bidirectional switches SWα and SWβ are in an on state, and power is supplied to the first winding portion α1 and the second winding portion α2 of the winding α in series with each other and the third winding portion β1 and the fourth winding portion β2 of the winding β in series with each other by switching control of the first leg L1, the fourth leg L4, the fifth leg L5, and the eighth leg L8. As a result, in this series winding mode, the current flows through the series winding including a larger number of windings, so that the torque can be efficiently generated with a smaller current, and high torque performance can be obtained in a low rotation range.

### Parallel Winding Mode

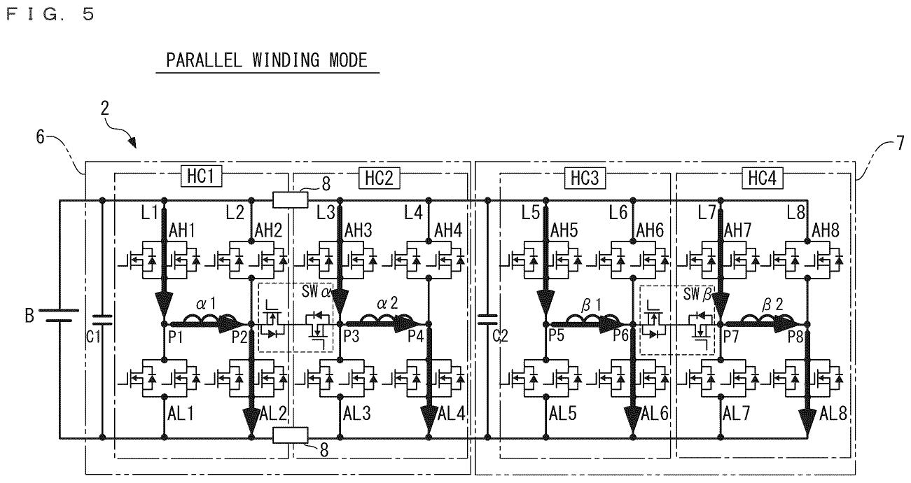

As illustrated in FIG. 5, in the parallel winding mode, both the first and second bidirectional switches SWα and SWβ are in an off state, and power is supplied to the first winding portion α1 and the second winding portion α 2 of the winding α parallel to each other and the third winding portion β1 and the fourth winding portion β2 of the winding β parallel to each other by switching control of the first to eighth legs L1 to L8. As a result, in the parallel winding mode, the current flows through each of the pair of parallel windings, so that a larger output can be generated with a large current as a whole, and high output performance can be obtained in a high rotation range.

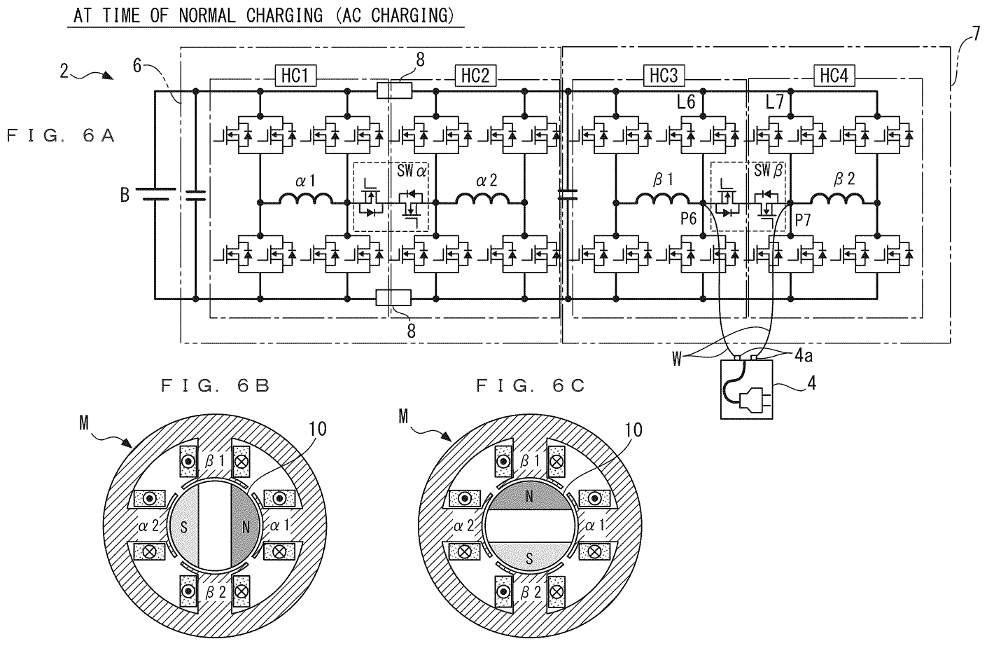

Next, a charging operation by the charging system 1 will be described with reference to FIGS. 6A to 14. FIGS. 6A to 6C illustrate a connection state between the power supply/charging circuit 2 and the external power supply 4 at the time of normal charging (AC charging) and an angular position of the rotor 10 of the motor M. As illustrated in FIG. 6A, at the time of normal charging, two input/output terminals 4a and 4a of the external power supply 4 are connected to the midpoint P6 of the sixth leg L6 and the midpoint P7 of the seventh leg L7 via electric wires W.

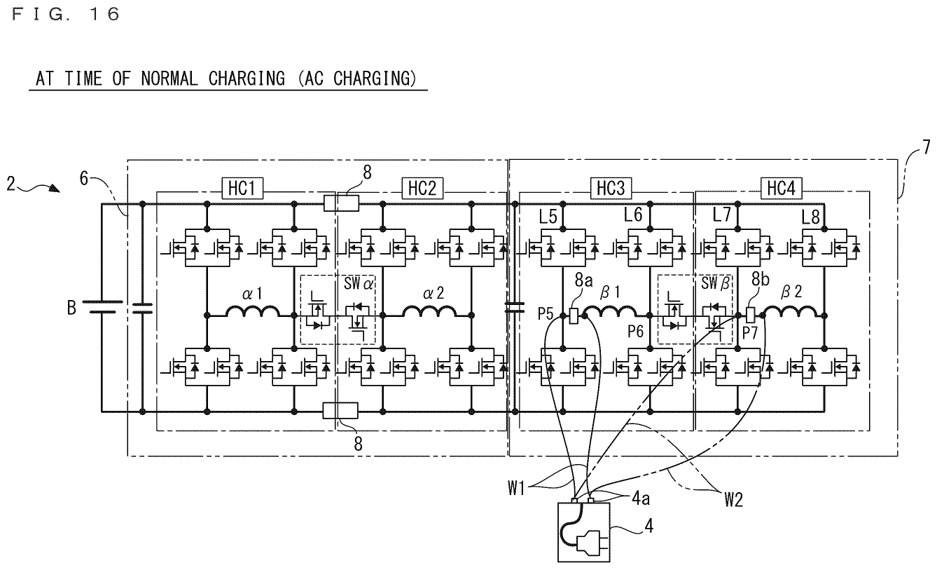

In addition, the rotor 10 of the motor M is controlled to stop at an angular position where the direction of the magnetic pole matches the winding α or the winding β. Specifically, for example, the angular position of the rotor 10 is controlled such that the direction of the magnetic pole of the rotor 10 matches the winding α including the first winding portion α1 and the second winding portion α2 as illustrated in FIG. 6B, or matches the winding β including the third winding portion β1 and the fourth winding portion β2 as illustrated in FIG. 6C. Then, the charge characteristics are improved by controlling the mutual inductance by the charging method. For example, at the time of AC charging in FIGS. 6A to 6C and 16, the third winding portion β1 and the fourth winding portion β2 are utilized as a power factor correction circuit, and the first winding portion α1 and the second winding portion α2 are caused to function as an isolated bidirectional DC-DC converter, and therefore, when the mutual inductance of the α phase and the β phase is reduced, the ripple current due to the magnetic interference is reduced, and the charging efficiency is improved.

In addition, at the time of normal charging, both the first and second bidirectional switches SWα and SWβ are in an off state, and both contactors 8 and 8 between the second leg L2 and the third leg L3 are in an off state.

Then, at the time of normal charging, the control device 3 executes switching control of the on/off states of the switching elements of the first to fourth H-bridge circuits HC1 to HC4 in the above-described state. In this case, the second circuit 7 of the third and fourth H-bridge circuits HC3 and HC4 functions as a power factor correction circuit (PFC circuit), while the first circuit 6 of the first and second H-bridge circuits HC1 and HC2 functions as an isolated DC-DC converter. Since the above-described second circuit 7 functions as a PFC circuit, it is possible to reduce a harmonic component of the alternating current of the external power supply 4 and to approximate to the sine wave of the fundamental wave. In addition, when the above-described first circuit 6 functions as an isolated DC-DC converter, the direct current from the second circuit 7 can be converted into a predetermined voltage, and the battery B can be efficiently charged.

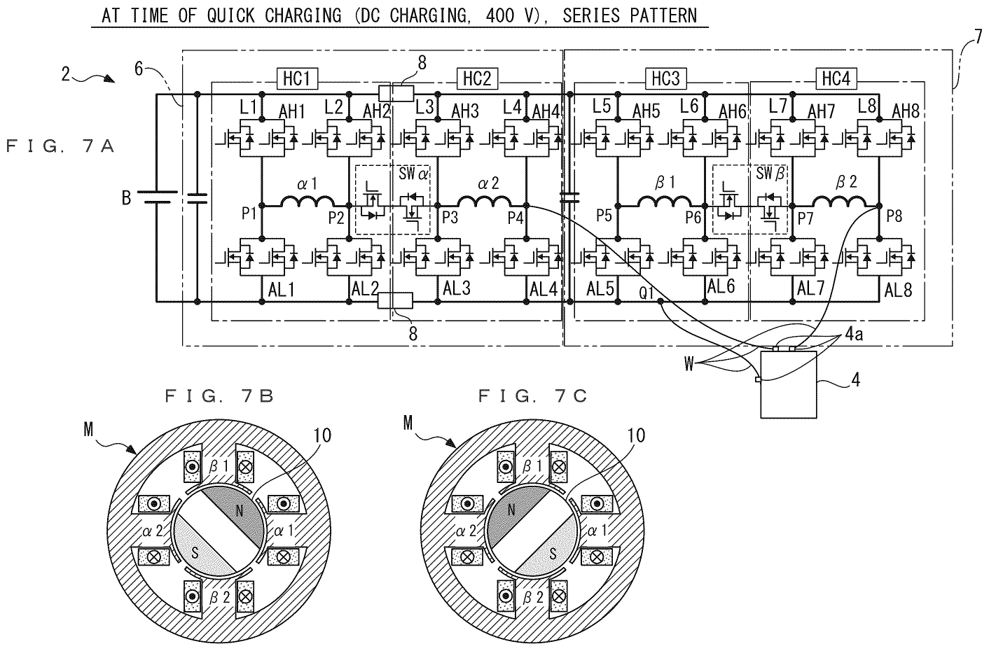

FIGS. 7A to 7C illustrate a connection state between the power supply/charging circuit 2 in a series pattern and the external power supply 4 at the time of quick charging (DC charging, 400 V) and an angular position of the rotor 10 of the motor M. As illustrated in FIG. 7A, at the time of quick charging, the input/output terminals 4a of the external power supply 4 are connected to the midpoint P4 of the fourth leg L4 and the midpoint P8 of the eighth leg L8 via the electric wires W, and the input/output terminal 4a of the external power supply 4 is connected to a predetermined point Q1 between the fifth lower arm AL5 of the fifth leg L5 and the sixth lower arm AL6 of the sixth leg L6 via the electric wire W.

In addition, the angular position of the rotor 10 of the motor M is not particularly limited, but for example, the direction of the magnetic pole of the rotor 10 is controlled to stop at the angular position located between the winding α and the winding β (see FIGS. 7B and 7C). Further, in quick charging, both the first and second bidirectional switches SWα and SWβ are in an on state, and both contactors 8 and 8 between the second leg L2 and the third leg L3 are in an on state.

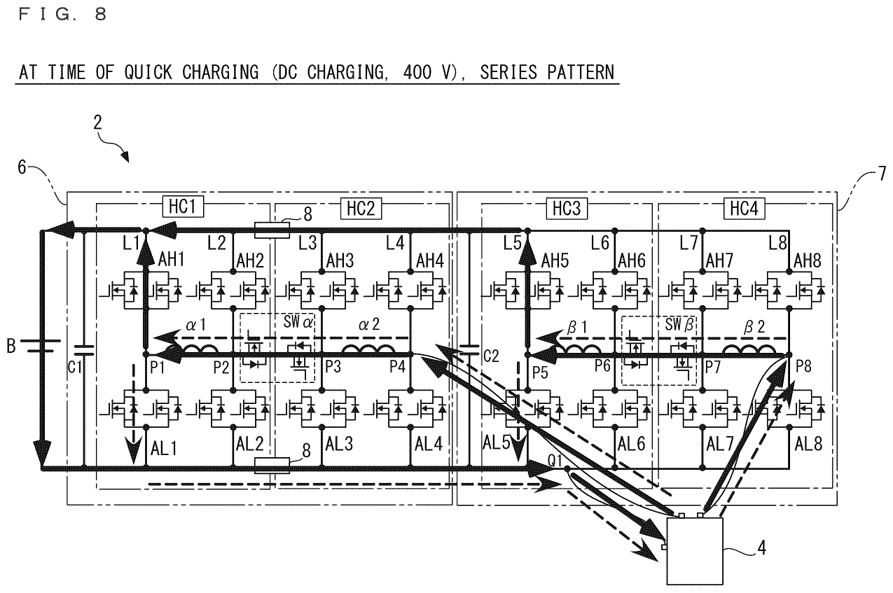

Then, the control device 3 executes switching control of the on/off states of the switching elements of the first to fourth H-bridge circuits HC1 to HC4 in the above-described state. FIG. 8 illustrates an operation of the power supply/charging circuit 2 at the time of quick charging of FIGS. 7A to 7C. As illustrated in FIG. 8, at the time of quick charging, the on/off states of the switching elements are controlled to be switched such that direct current from the external power supply 4 flows as indicated by the broken line arrows, whereby the current is stored in the first and second winding portions α1 and α2 of the winding α and the third and fourth winding portions β1 and β2 of the winding β, which are inductors. Then, by switching predetermined switching elements, the boosted current flows as indicated by the solid arrows in FIG. 8, and the battery B is charged. Note that, in this case, although an iron loss occurs because the current flows through the windings α and β, a large inductance of the motor M can be used, so that the current ripple can be reduced.

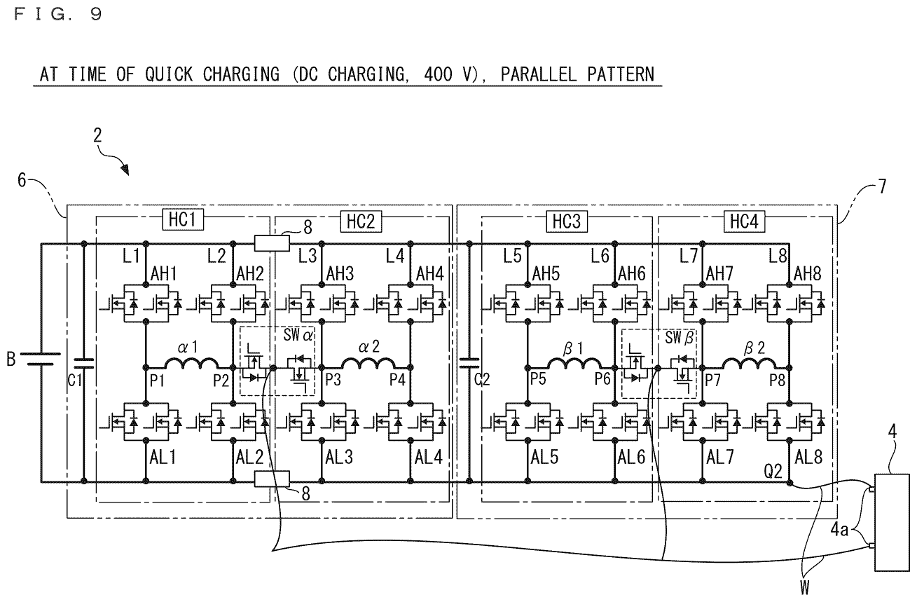

FIG. 9 illustrates a connection state between the power supply/charging circuit 2 in a parallel pattern and the external power supply 4 at the time of quick charging (DC charging, 400 V). As illustrated in the figure, at the time of quick charging, the input/output terminal 4a of the external power supply 4 is connected to the first and second bidirectional switches SWα and SWβ via the electric wire W. Specifically, in both bidirectional switches SWα and SWβ, the input/output terminal 4a of the external power supply 4 is connected between the two switching elements. Note that another input/output terminal 4a of the external power supply 4 is connected to a predetermined point Q2 between the seventh lower arm AL7 of the seventh leg L7 and the eighth lower arm AL8 of the eighth leg L8 via the electric wire W.

In addition, the angular position of the rotor 10 of the motor M is not particularly limited as in the case of the quick charging in FIGS. 7A to 7C described above. Further, in quick charging, both the first and second bidirectional switches SWα and SWβ are in an on state, and both contactors 8 and 8 between the second leg L2 and the third leg L3 are in an on state.

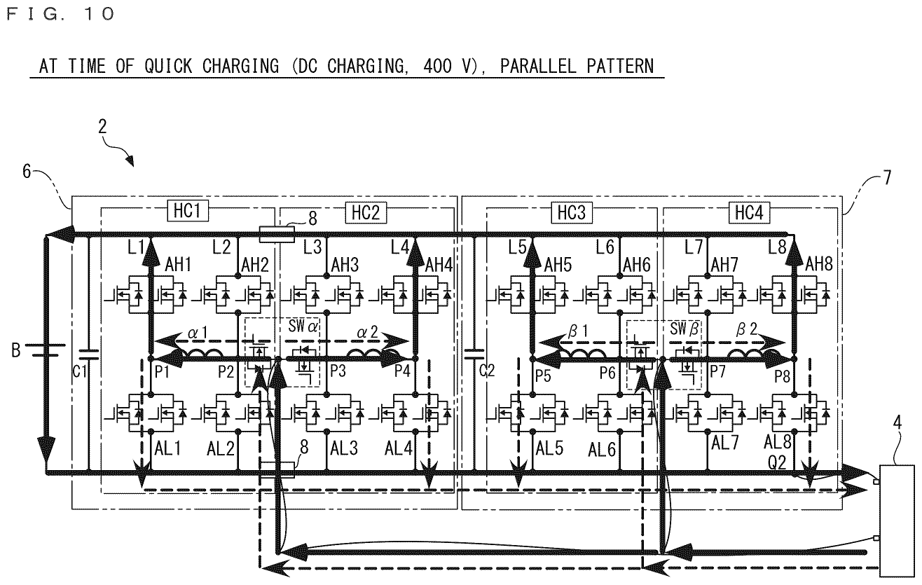

Then, the control device 3 executes switching control of the on/off states of the switching elements of the first to fourth H-bridge circuits HC1 to HC4 in the above-described state. FIG. 10 illustrates an operation of the power supply/charging circuit 2 at the time of quick charging of FIG. 9. As illustrated in FIG. 10, at the time of quick charging, the on/off states of the switching elements are controlled to be switched such that direct current from the external power supply 4 flows as indicated by the broken line arrows, whereby the current is stored in the first and second winding portions α1 and α2 of the winding α and the third and fourth winding portions β1 and β2 of the winding β, which are inductors. Then, by switching predetermined switching elements, the boosted current flows as indicated by the solid arrows in FIG. 10, and the battery B is charged. Note that, in this case, since currents in opposite directions to each other flow in the first winding portion α1 and the second winding portion α2 of the winding α and the third winding portion β1 and the fourth winding portion β2 of the winding β, the magnetic flux generated in the motor M is canceled, and the iron loss can be greatly reduced. In addition, the above-described method is a mechanism of boosting by a leakage inductance portion of the motor that is not magnetically coupled.

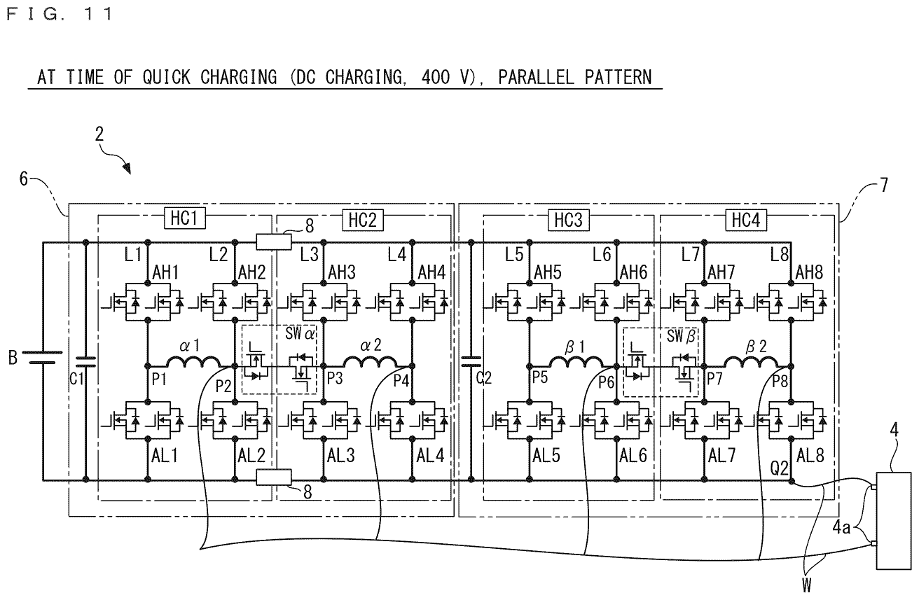

FIG. 11 illustrates a connection state between the power supply/charging circuit 2 in another parallel pattern and the external power supply 4 at the time of quick charging (DC charging, 400 V). As illustrated in the drawing, at the time of quick charging, the input/output terminal 4a of the external power supply 4 is connected to one end of the first winding portion α1 and the second winding portion α2 of the winding α and the third winding portion β1 and the fourth winding portion β2 of the winding β via the electric wire W. Specifically, the input/output terminal 4a of the external power supply 4 is connected to the midpoint P2 of the second leg L2, the midpoint P4 of the fourth leg L4, the midpoint P6 of the sixth leg L6, and the midpoint P8 of the eighth leg L8. Note that another input/output terminal 4a of the external power supply 4 is connected to a predetermined point Q2 between the seventh lower arm AL7 of the seventh leg L7 and the eighth lower arm AL8 of the eighth leg L8 via the electric wire W.

In addition, the angular position of the rotor 10 of the motor M is not particularly limited as in the case of the quick charging in FIGS. 7A to 7C described above. Further, in quick charging, both the first and second bidirectional switches SWα and SWβ are in an off state, and both contactors 8 and 8 between the second leg L2 and the third leg L3 are in an on state.

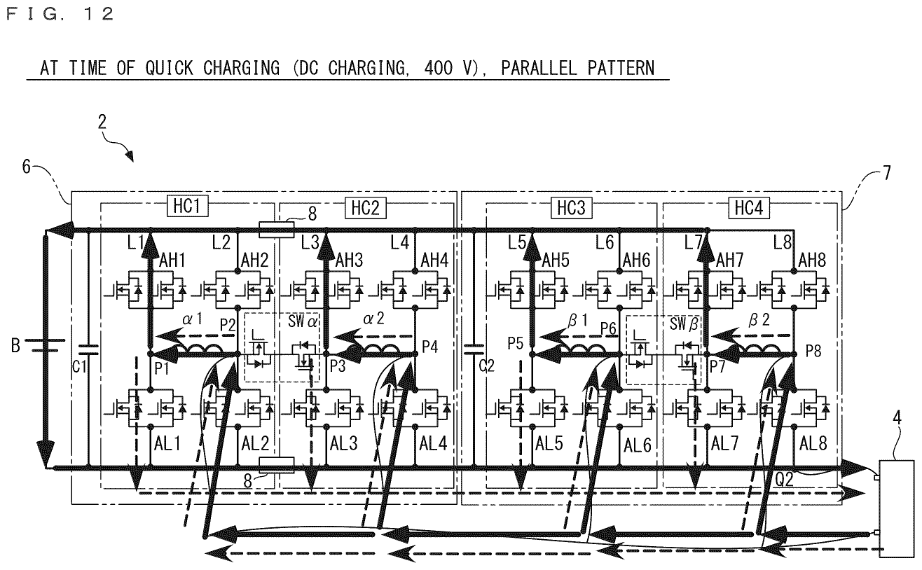

Then, the control device 3 executes switching control of the on/off states of the switching elements of the first to fourth H-bridge circuits HC1 to HC4 in the above-described state. FIG. 12 illustrates an operation of the power supply/charging circuit 2 at the time of quick charging of FIG. 11. As illustrated in FIG. 12, at the time of quick charging, the on/off states of the switching elements are controlled to be switched such that direct current from the external power supply 4 flows as indicated by the broken line arrows, whereby the current is stored in the first and second winding portions α1 and α2 of the winding α and the third and fourth winding portions β1 and β2 of the winding β, which are inductors. Then, by switching predetermined switching elements, the boosted current flows as indicated by the solid arrows in FIG. 12, and the battery B is charged.

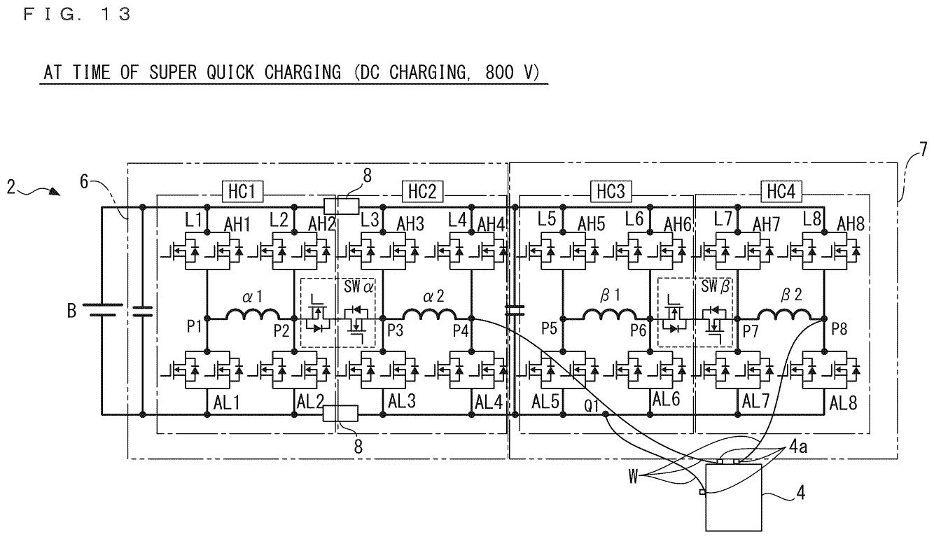

FIG. 13 illustrates a connection state between the power supply/charging circuit 2 and the external power supply 4 at the time of super quick charging (DC charging, 800 V). As illustrated in the drawing, at the time of super quick charging, similarly to the time of quick charging in FIGS. 7A to 7C described above, the input/output terminals 4a of the external power supply 4 are connected to the midpoint P4 of the fourth leg L4 and the midpoint P8 of the eighth leg L8 via the electric wires W, and another input/output terminal 4a of the external power supply 4 is connected to a predetermined point Q1 between the fifth lower arm AL5 of the fifth leg L5 and the sixth lower arm AL6 of the sixth leg L6 via the electric wire W.

In addition, the angular position of the rotor 10 of the motor M is not particularly limited as in the case of the quick charging in FIGS. 7A to 7C described above. Further, at the time of super quick charging, both the first and second bidirectional switches SWα and SWβ are in an on state, and both contactors 8 and 8 between the second leg L2 and the third leg L3 are in an on state.

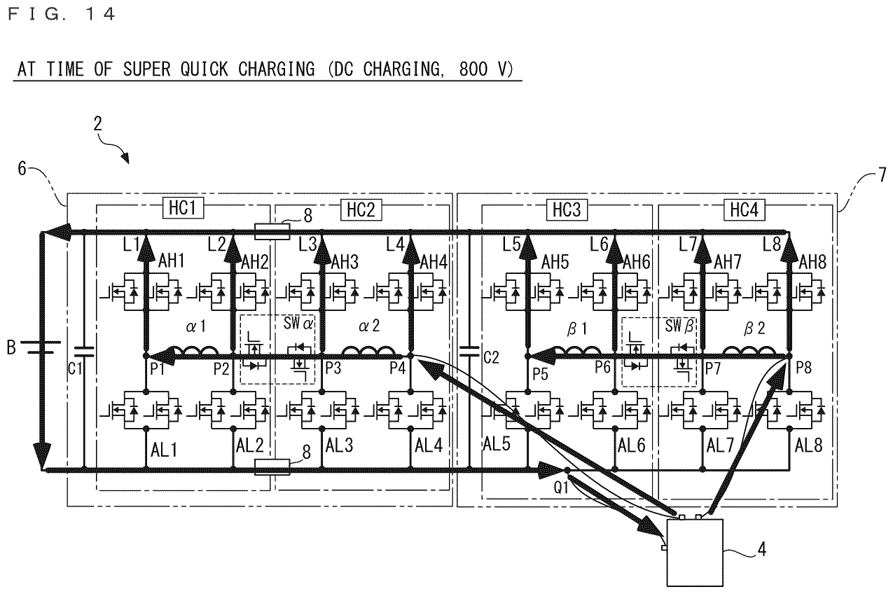

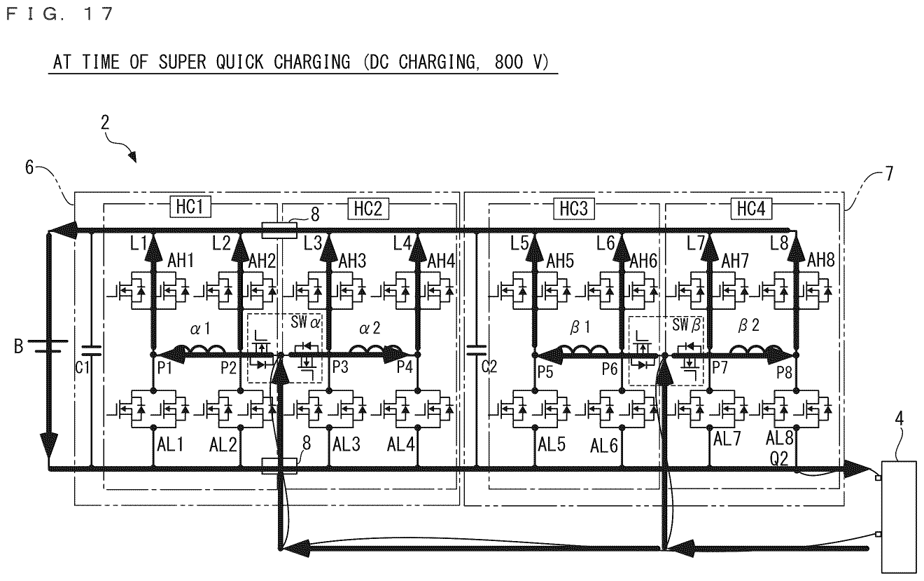

Then, the control device 3 executes switching control of the on/off states of the switching elements of the first to fourth H-bridge circuits HC1 to HC4 in the above-described state. FIG. 14 illustrates an operation of the power supply/charging circuit 2 at the time of super quick charging of FIG. 13. As illustrated in FIG. 14, at the time of super quick charging, the external power supply 4 is higher than the voltage of the battery B, so that the current from the external power supply 4 flows as indicated by the solid arrows, and the battery B is charged. Note that, the current from the external power supply 4 may flow as illustrated in FIG. 17 instead of FIG. 14.

As described above, with the charging system 1 of the present embodiment, it is possible to perform normal charging by AC charging in addition to quick charging by DC charging using the motor M for driving mounted on the electric vehicle and the power supply/charging circuit 2 as an inverter. Therefore, in the charging system 1, unlike the conventional art, the in-vehicle charger can be omitted, so that the number of components and cost of the entire charging system can be reduced.

Note that the present invention is not limited to the above-described embodiment, and can be implemented in various modes.

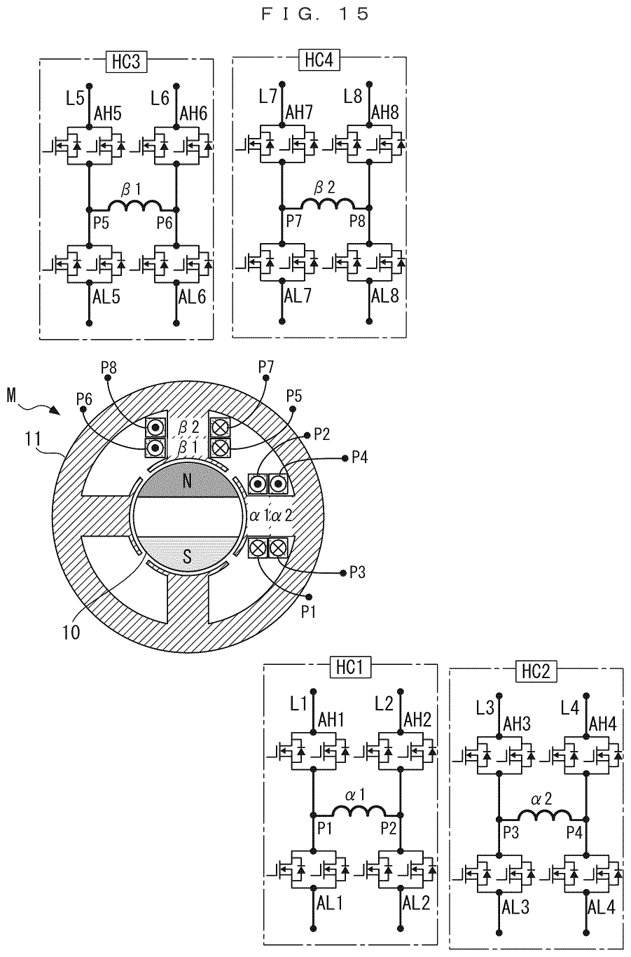

FIG. 15 illustrates a state in which the first winding portion α1 and the second winding portion α2 are wound around a common tooth of the stator 11, and the third winding portion β1 and the fourth winding portion β2 are wound around a common tooth of the stator 11. The state illustrated in the drawing is equivalent to that in FIG. 2 described above, and the motor M may have any structure as long as the phase angles of the winding α and the winding β are 90 degrees in terms of electrical angle. In addition, in the embodiment, the winding method is the concentrated winding for one pole pair, but instead of this, distributed winding may be used.

In addition, during normal charging, as illustrated in FIG. 16, the external power supply 4 and the second circuit 7 of the power supply/charging circuit 2 may be connected. As illustrated in the drawing, specifically, the input/output terminals 4a and 4a of the external power supply 4 may be connected to the midpoint P5 of the fifth leg L5 and an end of the third winding portion β1 on the midpoint P5 side in the second circuit 7 via electric wires W1 indicated by the solid lines. Note that, in this case, a contactor 8a is provided between the above-described midpoint P5 and the above-described end of the third winding portion β1, and the third winding portion β1 is in a state of being removed from the midpoint P5 of the fifth leg L5 by the contactor 8a during normal charging.

Further, instead of the above, the input/output terminals 4a and 4a of the external power supply 4 may be connected to the midpoint P7 of the seventh leg L7 and an end of the fourth winding portion β2 on the midpoint P7 side in the second circuit 7 via electric wires W2 indicated by the two-dot chain lines. Note that, in this case, a contactor 8b is provided between the above-described midpoint P7 and the above-described end of the fourth winding portion β2, and the fourth winding portion β2 is in a state of being removed from the midpoint P7 of the seventh leg L7 by the contactor 8b during normal charging.

At the time of normal charging in FIGS. 6A to 6C described above, the second circuit 7 using the inductances of the third winding portion β1 and the fourth winding portion β2 is used as a PFC circuit, and alternating current from the external power supply 4 is converted into direct current using the fifth leg L5 and the eighth leg L8. However, when current flows through the diode in the sixth leg L6 or the seventh leg L7, controllability may be deteriorated or unnecessary current may flow. Thus, in order to solve such a problem, the connection between the external power supply 4 and the second circuit 7 in FIG. 16 described above may cause the second circuit 7 to function as a PFC circuit without using the fourth winding portion β2 or the third winding portion β1 at the time of normal charging.

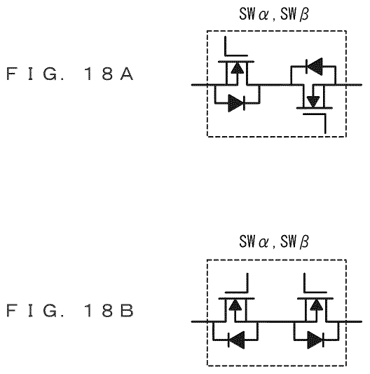

In addition, regarding the first and second bidirectional switches SWα and SWβ used in the power supply/charging circuit 2, the forward directions of the diodes are connected to each other in the two sets of circuits including the switching elements and the diodes in parallel with each other as illustrated in FIG. 18A, but the reverse directions of the diodes may be connected to each other as illustrated in FIG. 18B.

Further, although the first and second bidirectional switches SWα and SWβ are used in the power supply/charging circuit 2 described above, it is also possible to adopt a power supply/charging circuit in which these bidirectional switches SWα and SWβ are omitted.

In addition, the detailed configuration and the like of the charging system 1 described in the embodiment are merely examples, and can be appropriately changed within the scope of the gist of the present invention.

What is claimed is:

1. A charging system for an electric vehicle that charges a battery from an external power supply using a motor for driving of the electric vehicle, and an inverter, wherein
the motor includes
a rotor including a permanent magnet,
a stator disposed outside the rotor,
a winding of a first phase including a first winding portion and a second winding portion wound around the stator and facing each other with the rotor interposed therebetween, and
a winding of a second phase including a third winding portion and a fourth winding portion wound around the stator and facing each other with the rotor interposed therebetween, the winding of the second phase being disposed in a state of being displaced by 90 degrees in terms of electrical angle with respect to the winding of the first phase,
the inverter includes
first to fourth H-bridge circuits connected to the battery and connected to the first and second winding portions of the first phase and the third and fourth winding portions of the second phase, respectively, and
first and second bidirectional switches switching a bidirectional current flow through the first and second winding portions and a bidirectional current flow through the third and fourth winding portions, respectively, to an on state or an off state,
the first to fourth H-bridge circuits respectively include first and second legs, third and fourth legs, fifth and sixth legs, and seventh and eighth legs in which upper arms and lower arms each including a switching element are connected to each other at midpoints, and
the midpoints of the first and second legs are respectively connected to one end and an other end of the first winding portion, the midpoints of the third and fourth legs are respectively connected to one end and an other end of the second winding portion, the midpoints of the fifth and sixth legs are respectively connected to one end and an other end of the third winding portion, and the midpoints of the seventh and eighth legs are respectively connected to one end and an other end of the fourth winding portion,
the charging system comprising a control device that controls the first to fourth H-bridge circuits, the first and second bidirectional switches, and a stop position of the rotor,
the control device
charging the battery by controlling direct current from the external power supply to be applied to the first to fourth winding portions at time of DC charging, and
charging the battery by electrically connecting the external power supply to the third winding portion and/or the fourth winding portion and controlling the rotor to stop at a predetermined position at time of AC charging.

2. A charging system for an electric vehicle that charges a battery from an external power supply using a motor for driving of the electric vehicle, and an inverter, wherein
the motor includes
a rotor including a permanent magnet,
a stator disposed outside the rotor,
a winding of a first phase including a first winding portion and a second winding portion wound around the stator, and
a winding of a second phase including a third winding portion and a fourth winding portion wound around the stator, the winding of the second phase being disposed in a state of being displaced by 90 degrees in terms of electrical angle with respect to the winding of the first phase,
the inverter includes
first to fourth H-bridge circuits connected to the battery and connected to the first and second winding portions of the first phase and the third and fourth winding portions of the second phase, respectively,
the first to fourth H-bridge circuits respectively include first and second legs, third and fourth legs, fifth and sixth legs, and seventh and eighth legs in which upper arms and lower arms each including a switching element are connected to each other at midpoints, and
the midpoints of the first and second legs are respectively connected to one end and an other end of the first winding portion, the midpoints of the third and fourth legs are respectively connected to one end and an other end of the second winding portion, the midpoints of the fifth and sixth legs are respectively connected to one end and an other end of the third winding portion, and the midpoints of the seventh and eighth legs are respectively connected to one end and an other end of the fourth winding portion,
the charging system comprising a control device that controls the first to fourth H-bridge circuits,
the control device charging the battery by controlling to electrically connect the external power supply to the third winding portion and/or the fourth winding portion at time of AC charging.

3. The charging system for an electric vehicle according to claim 2, wherein the control device charges the battery by controlling direct current from the external power supply to be applied to the first to fourth winding portions at time of DC charging.

4. The charging system for an electric vehicle according to claim 1, wherein the control device controls the third and fourth H-bridge circuits to function as a power factor correction circuit and controls the first and second H-bridge circuits to function as an isolated DC-DC converter, at time of AC charging.
